(19) United States
(12) Patent Application Publication
(10) Pub. No.: US 2013/0210863 A1
(43) Pub. Date: Aug. 15, 2013

(54) SYNERGISTIC INSECTICIDAL MIXTURES

(71) Applicants: Assaf Dotan, Kfar Varburg (IL); Ganit Levi-Ruso, Beer-Sheva (IL)

(72) Inventors: Assaf Dotan, Kfar Varburg (IL); Ganit Levi-Ruso, Beer-Sheva (IL)

(73) Assignee: MAKHTESHIM CHEMICAL WORKS, LTD., Beer-Sheva (IL)

(21) Appl. No.: 13/811,508

(22) PCT Filed: Jul. 31, 2011
(86) PCT No.: PCT/IL2011/000620

§ 371 Date: Apr. 3, 2013

Related U.S. Application Data
(60) Provisional application No. 61/370,911, filed on Aug. 5, 2010.

(51) Int. Cl. A01N 53/00; A01N 47/34; A01N 43/40

(52) U.S. Cl. CPC A01N 53/00; A01N 43/40; A01N 47/34
USPC 514/341

(57) ABSTRACT

The present invention relates to synergistic insecticidal mixtures comprising a) a Pyrethroid insecticide (preferably bifenthrin), b) a Neonicotinoid insecticide (preferably imidacloprid) and c) a Benzoylphenyl urea insecticide (preferably novaluron) and to the related compositions and methods of controlling insects.

### BACKGROUND OF THE INVENTION

The present invention relates to a ternary insecticidal composition that comprises a combination of a) a Pyrethroid compound, b) a Neonicotinoid compound and c) a Benzoylphenylurea compound, the composition having synergistically enhanced activity, and to a method for controlling insect pests by using said composition.

The vulnerability of crops to pests makes pest control one of the major management components of the total crop production system. Insects are very destructive to crop plants and can significantly reduce crop yields and quality. Insecticides help minimize this damage by controlling insect pests. Many insecticidal agents and compositions are commercially available for these purposes.

Combinations of insecticides are typically used to broaden spectrum of control, to minimize the doses of chemicals used, to retard resistance development and to reduce the cost of the treatment through additive effect. Although many combinations of insecticidal agents have been studied, a synergistic effect is rarely attained.

Therefore, there is still a need for novel insecticidal compositions that exhibit synergistically enhanced action, a broader scope of activity and reduced cost of treatment.

### BRIEF SUMMARY OF THE INVENTION

The invention relates to a novel ternary synergistic insecticidal composition that comprises a combination of a) a Pyrethroid compound, b) a Neonicotinoid compound and c) a Benzoylphenylurea compound.

The present invention also relates to a method for synergistic control of insects by contacting the insect or their food supply, habitat, breeding grounds or their locus with a synergistically effective amount of a combination of a) a Pyrethroid compound, b) a Neonicotinoid compound and c) a Benzoylphenylurea compound.

The invention also relates to a method of protecting plants from attack or infestation by insects comprising contacting the plant, or the soil or water in which the plant is growing, with a synergistically effective amount of a combination of a) a Pyrethroid compound, b) a Neonicotinoid compound and c) a Benzoylphenylurea compound.

Furthermore, the invention also relates to a process for preparing a ternary synergistic insecticidal composition containing a) a Pyrethroid compound, b) a Neonicotinoid compound and c) a Benzoylphenylurea compound.

### DETAILED DESCRIPTION OF THE INVENTION

It has been surprisingly found that by combining insecticides having three different modes of action (MOA), i.e., systemic action, ingestion action and contact and stomach action, insecticidal compositions are produced that exhibit a broad spectrum of control and high efficacy against very wide range of insects, as well as knock down and long residual effect under different climate conditions.

Thus, an enhanced, synergistic insecticidal activity is observed when a ternary insecticidal composition that comprises a combination of a) a Pyrethroid compound, b) a Neonicotinoid compound and c) a Benzoylphenylurea compound is used for the control of insects.

Pyrethroids are a class of insecticides that act in a manner similar to pyrethrins, which are derived from chrysanthemum flowers. Pyrethroids are widely used for controlling various insects.

Neonicotinoids are a class of insecticides which act on the central nervous system of insects with lower toxicity to mammals. Neonicotinoids are among the most widely used insecticides worldwide.

Benzoylphenylureas are a class of insecticides that act by interfering with the formation of chitin and, thus, blocking molting to the next larval stage. In this way, the life cycle of the insect is interrupted. Benzoylphenylurea insecticides are used as nonsystemic insect growth regulators for control of a wide range of leaf-eating insects and their larvae.

In an embodiment, the Pyrethroid compound is allethrin, bifenthrin, cyfluthrin, beta-cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, or a combination comprising at least one of the foregoing. In one representative embodiment, the Pyrethroid compound is bifenthrin.

In another embodiment, the Neonicotinoid compound is acetamiprid, clothianidin, imidacloprid, nitenpyram, thiacloprid, thiamethoxam or a combination comprising at least one of the foregoing. In one representative embodiment, the Neonicotinoid compound is imidacloprid.

In yet another embodiment, the Benzoylphenylurea compound is bistrifluoron, chlorfluazuron, diflubenzuron, flucycloxuron, flufenoxuron, hexaflumaron, lufenuron, novaluron, noviflumuron, teflubenzuron, triflumuron or a combination comprising at least one of the foregoing. In one representative embodiment, the Benzoylphenylurea compound is novaluron.

In some embodiments, the ternary insecticidal compositions comprise a combination of a) bifenthrin, b) a Neonicotinoid compound and c) a Benzoylphenylurea. Alternatively, the ternary insecticidal composition can comprise a combination of a) a Pyrethroid compound, b) imidacloprid and c) a Benzoylphenylurea. The ternary insecticidal composition can alternatively comprise a combination of a) a Pyrethroid compound, b) a Neonicotinoid compound and c) novaluron. The ternary insecticidal composition can alternatively comprise a combination of a) a Pyrethroid compound, b) imidacloprid and c) novaluron. In yet another embodiment, the ternary insecticidal composition comprises a combination of a) bifenthrin, b) a Neonicotinoid compound and c) novaluron. In yet another embodiment, the ternary insecticidal composition comprises a combination of a) bifenthrin, b) imidacloprid and c) a Benzoylphenylurea. In yet another embodiment, the ternary insecticidal composition comprises a combination of a) bifenthrin, b) imidacloprid and c) novaluron.

In another embodiment, the ratio (by weight) of the Pyrethroid compound to the Neonicotinoid compound is from 1:100 to 100:1, in particular, from 1:25 to 25:1 and more particularly from 1:10 to 10:1.

In yet another embodiment, the ratio (by weight) of bifenthrin to imidacloprid is from 1:100 to 100:1, in particular, from 1:25 to 25:1, more particularly from 1:10 to 10:1, even more particularly, the ratio of the amount of bifenthrin to the amount of imidacloprid is 1:8.75.

In another embodiment, the ratio (by weight) of the Pyrethroid compound to the Benzoylphenylurea compound is from 1:100 to 100:1, in particular, from 1:20 to 20:1 and more particularly from 1:5 to 5:1.

In yet another embodiment, the ratio (by weight) of bifenthrin to novaluron is from 1:100 to 100:1, in particular, from 1:20 to 20:1, more particularly from 1:5 to 5:1, even more particularly, the ratio of the amount of bifenthrin to the amount of novaluron is 1:1.5.

In another embodiment, a method for synergistic control of insects by contacting the insect or their food supply, habitat, breeding grounds or their locus with a synergistically effective amount of a combination of a) a Pyrethroid compound, b) a Neonicotinoid compound and c) a Benzoylphenylurea compound is provided.

For example, a method for synergistic control of insects by contacting the insect or their food supply, habitat, breeding grounds or their locus with a synergistically effective amount of a combination of a) bifenthrin, b) imidacloprid and c) novaluron is provided.

In another embodiment, a method of protecting plants from attack or infestation by insects comprising contacting the plant, or the soil or water in which the plant is growing, with a synergistically effective amount of a combination of a) a Pyrethroid compound, b) a Neonicotinoid compound and c) a Benzoylphenylurea compound is provided.

For example, a method of protecting plants from attack or infestation by insects comprising contacting the plant, or the soil or water in which the plant is growing, with a synergistically effective amount of a mixture of a) bifenthrin, b) imidacloprid and c) novaluron is provided.

In yet another embodiment, the plants include vegetables, such as tomatoes, peppers, cabbage, broccoli, lettuce, spinach, cauliflower, melon, watermelon, cucumbers, carrots, onions and potatoes, tobacco, pome and stone fruits, such as walnuts, kiwi, berries, olive, almonds, pineapples, apples, pears, plums, peaches, and cherries, table and wine grapes, citrus fruit, such as oranges, lemons, grapefruits and limes, cotton, soybean, oil seed rape, wheat, barley, maize, sorghum, sunflower, peanuts, rice, pasture, coffee, beans, peas, yucca, sugar cane, clover and ornamentals such as roses.

In still another embodiment, the plants include plants which tolerate the action of herbicides, fungicides or insecticides as a result of breeding and/or genetically engineered methods.

In another embodiment, the insect pests are of the order Coleoptera, such as Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

In yet another embodiment, the insect pests are of the order Diptera, such as Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cocliliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (grass fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies) and Tipula spp. (crane flies).

In yet another embodiment, the insect pests are of the order Hemiptera, such as Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

In yet another embodiment, the insect pests are of the order Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

In yet another embodiment, the insect pests are of the order Lepidoptera, such as Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera fugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

In yet another embodiment, the insect pests are of the order Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), chistocerca gregaria, Scudderia furcata (forktailed bush katydid) and Valanga nigricorni.

In yet another embodiment, the insect pests are of the order Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

In another embodiment, the Pyrethroid compound, the Neonicotinoid compound and the Benzoylphenylurea compound can be applied simultaneously, that is jointly or separately, or in succession, the sequence, in the case of separate application, generally not having any effect on the result of the control measures.

For example, the bifenthrin, the imidacloprid and the novaluron can be applied simultaneously, that is jointly or separately, or in succession, the sequence, in the case of separate application, generally not having any effect on the result of the control measures.

The application rates of the combination may vary, depending on the desired effect. In an embodiment, depending on the desired effect, the application rates of the mixtures according to the invention are from 10 g/ha to 2000 g/ha, particularly from 50 to 1500 g/ha, more particularly from 90 to 1100 g/ha.

In yet another embodiment, the synergistic composition may be applied in various mixtures or combinations of the Pyrethroid compound, the Neonicotinoid compound and the Benzoylphenylurea compound, for example in a single “Ready-to-use” form, or in a combined spray mixture composed from separate formulations of the single active ingredients, such as a “tank-mix” form.

In yet another embodiment, the composition is applied in the form of a Ready-to-use formulation comprising the Pyrethroid compound, the Neonicotinoid compound and the Benzoylphenylurea compound. This formulation can be obtained by combining the three active ingredients with an agriculturally acceptable carrier.

For example, the composition of the present invention is preferably applied in the form of a Ready-to-use formulation comprising bifenthrin, imidacloprid and novaluron, which can be obtained by combining the three active ingredients with an agriculturally acceptable carrier.

Ready-to-use compositions containing the Pyrethroid compound, the Neonicotinoid compound and the Benzoylphenylurea compound may be employed in any conventional form, for example, in the form of a twin pack, or as an emulsifiable concentrate, an oil-in-water emulsion, soluble concentrate, suspension concentrate, microemulsion, wettable powder, ready-to-spray solution, soluble granule and water-dispersible granule. Such compositions can be formulated using agriculturally acceptable carrier(s) and formulation techniques that are known in the art.

In yet another embodiment, the composition is applied in the form of emulsion concentrates (EC), suspension concentrates (SC), water dispersible granules (WDG) and wettable powders (WP), more particularly in the form of suspension concentrates.

In another embodiment, the combined amount of the Pyrethroid compound, the Neonicotinoid compound and the Benzoylphenylurea compound together in the ready-to-use suspension concentrates formulations is 1-55 wt. %, particularly 5-25 wt. %, based on the total weight of the formulation.

For example, the combined amount of bifenthrin, imidacloprid and novaluron in the ready-to-use suspension concentrates formulations according to the invention is 1-55 wt. %, particularly 5-25 wt. %, more particularly is 20-25 wt. %, based on the total weight of the formulation.

In another embodiment, the suspensions are prepared by finely grinding the components of the synergistic combination either together or separately, and vigorously mixing the ground material into a vehicle comprised of water, organic solvent and surfactants. The term surfactant, as used herein, means an agriculturally acceptable material which imparts emulsifiability, stability, spreading, wetting, dispersibility or other surface-modifying properties. Examples of suitable surfactants include non-ionic, anionic, cationic and ampholytic types such as lignin sulfonates, fatty acid sulfonates (e.g. lauryl sulfonate), condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols and ethoxylated fatty alcohols. Other ingredients, such as wetting agents, adhesives, thickeners, binders, fertilizers or anti-freeze agents, may also be added to increase the density and viscosity of the aqueous vehicle.

Specifically, in an embodiment the suspensions are prepared by the following steps:

(a) preparing a suspension of the benzoylphenylurea compound by mixing solution of the Benzoylphenylurea compound in DMSO and water;
(b) preparing a suspension of the Pyrethroid compound and the neonicotinoid in water; and
(c) adding the suspension obtained in (a) to the suspension obtained in (b) while shearing with high shear.

For example, the suspensions may be prepared by the following steps:

(a) preparing a suspension of novaluron by mixing solution of novaluron in DMSO with water;
(b) preparing a suspension of bifenthrin and imidacloprid in water; and
(c) adding the suspension obtained in (a) to the suspension obtained in (b) while shearing with high shear.

In another embodiment, the present invention provides a kit comprising a ternary synergistic insecticidal composition as described herein, or components thereof. Such kits may comprise, in addition to the aforementioned active components, one or more additional active and/or inactive ingredients, either within the provided insecticidal composition or separately. Certain kits comprise a) a Pyrethroid compound, b) a Neonicotinoid compound and c) a Benzoylphenylurea compound, each in a separate container, and each optionally combined with a carrier.

As noted above, the compositions, kits and methods described herein exhibit a synergistic effect. A synergistic effect exists wherever the action of a combination of active components is greater than the sum of the action of each of the components alone. Therefore, a synergistically effective amount (or an effective amount of a synergistic composition or combination) is an amount that exhibits greater insecticidal activity than the sum of the insecticidal activities of the individual components.

The following examples illustrate the practice of the present invention in some of its embodiments, but should not be construed as limiting the scope of the invention. Other embodiments will be apparent to one skilled in the art from consideration of the specification and examples. It is intended that the specification, including the examples, is considered exemplary only without limiting the scope and spirit of the invention.

### FORMULATION EXAMPLE

This Example illustrates the preparation of a representative synergistic insecticidal composition concentrate.

A suspension concentrate is prepared by combining the ingredients in the amounts indicated in the following table:

Suspension Concentrate

| Ingredient | Weight percent |
|---|---|
| Bifenthrin | 2.0% |
| Imidacloprid | 17.5% |
| Novaluron | 3.0% |
| Naphthalene formaldehyde | 1.5% |
| condensate | |
| Methyl methacrylate graft | 3.5% |
| copolymer | |
| Ethoxylated polyaryl phenol | 3.9% |
| Ethylene oxide propylene | 3.9% |
| oxide block copolymer | |
| Polyethylene glycol | 4.5% |
| DMSO | 4.5% |
| Preservative | 0.2% |
| Antifoam | 1.1% |
| Xanthan gum | 0.4% |
| Antifreeze | 8.0% |
| Water | Up to 100% |

### BIOLOGICAL EXAMPLES

A synergistic effect exists whenever the action of an active ingredient combination is greater than the sum of the actions of the individual components.

In the field of agriculture, it is often understood that the term “synergy” is as defined by Colby S. R. in an article entitled “Calculation of the synergistic and antagonistic responses of herbicide combinations” published in the journal Weeds, 1967, 15, p. 20-22. The action expected for a given combination of two active components can be calculated as follows:

$$E = X + Y - \frac{XY}{100}$$

The action expected for a given combination of three active components can be calculated as follows:

$$E = X + Y + Z - \frac{XY + XZ + YZ}{100} + \frac{XYZ}{10000}$$

in which E represents the expected percentage of insecticidal control for the combination of the three insecticides at defined doses (for example equal to x, y and z respectively), X is the percentage of insecticidal control observed by the compound (I) at a defined dose (equal to x), Y is the percentage of insecticidal control observed by the compound (II) at a defined dose (equal to y), Z is the percentage of insecticidal control observed by the compound (III) at a defined dose (equal to z). When the percentage of insecticidal control observed for the combination is greater than the expected percentage, there is a synergistic effect.

Experiments were carried out to determine the synergistic insecticidal effect of the ternary insecticidal composition which comprises a mixture of a) a Pyrethroid compound, b) a Neonicotinoid compound and c) a Benzoylphenylurea compound.

Two field trials were conducted on tomato to evaluate the insecticidal control of whitefly nymphs with Pyrethroid compound (bifenthrin), Neonicotinoid compound (imidacloprid) and Benzoylphenylurea compound (novaluron), alone and in ternary mixture, as a foliar application. The ternary mixture prepared by the process described in the above example. Commercially available compositions of bifenthrin (Seizer 10 EC), imidacloprid (Kohinor 35 SC) and novaluron (Rimon Supra 10 SC) were diluted with water to the stated concentration of the active compound.

Applications were made with a backpack type sprayer fitted with a pressure regulator and a vertical bar with four hollow cone nozzles. Experiment design was in random blocks with four repetitions, and each plot was comprised of seven-meter-long double ridges. The rate of application was 700 l/ha and 750 l/ha in trial 1 and trial 2 respectively. The number of nymphs per foliole on the sixth leaf was assessed 21 days post-application (DAA).

Table 1 below summarizes the impacts of separate and combined treatments at different concentrations of bifenthrin, imidacloprid and novaluron.

TABLE 1
Control of White Fly Nymphs in Tomato 21 DAA

| | | % of | % of | % of | % of | |
|---|---|---|---|---|---|---|
| | | control | control | control | control | Colby |
| | | observed | observed | observed | expected | Ratio |
| AI | g/100 L | Trial 1 | Trial 2 | Avg. | Avg. | o/e |
| Bifenthrin | 3 | 19.3 | 5.1 | 12.2 | | |
| Imidacloprid | 26.25 | 30.7 | 26 | 28.4 | | |
| Novaluron | 4.5 | 24.3 | 26.4 | 25.4 | | |
| Bifenthrin + | 26.25 + 4.5 + 3 | 66.3 | 65.1 | 65.7 | 53.0 | 1.2 |
| Imidacloprid + | | | | | | |
| Novaluron | | | | | | |
| Bifenthrin | 2 | 0 | 0 | 0.0 | | |
| Imidacloprid | 17.5 | 22.3 | 11.5 | 16.9 | | |
| Novaluron | 3 | 13.9 | 19.6 | 16.8 | | |
| Bifenthrin + | 17.5 + 3 + 2 | 53 | 52.3 | 52.7 | 30.8 | 1.7 |
| Imidacloprid + | | | | | | |
| Novaluron | | | | | | |
| Bifenthrin | 1 | 0 | 0 | 0.0 | | |
| Imidacloprid | 8.75 | 7.4 | 0 | 3.7 | | |
| Novaluron | 1.5 | 4.5 | 5.1 | 4.8 | | |
| Bifenthrin + | 8.75 + 1.5 + 1 | 45 | 35.7 | 40.4 | 8.3 | 4.8 |
| Imidacloprid + | | | | | | |
| Novaluron | | | | | | |

For each treatment, the nymphs per foliole on the sixth leaf are presented as a percentage of the control (no insecticidal treatment). The expected percent of control was determined using the method of Colby S. R. as discussed above, and the Colby ratio (observed average/expected average) was calculated. When the percentage of insecticidal control observed for the combination is greater than the expected percentage (i.e., the Colby ratio is greater than 1), there is a synergistic effect.

Based on the results presented hereinabove, the ternary insecticidal composition which comprises a combination of a) a Pyrethroid compound, b) a Neonicotinoid compound and c) a Benzoylphenylurea compound was found to exhibit strong synergistic effects against insects. Such combinations are suitable for controlling of insects in a plant or in the environment in which such a plant is grown or stored, such as soil, storage containers, etc.

1. A ternary insecticidal composition comprising, as active components a) a pyrethroid compound, b) a neonicotinoid compound and c) a benzoylphenylurea compound in a synergistically effective amount.

2. The composition of claim 1, wherein said pyrethroid compound is allethrin, bifenthrin, cyfluthrin, beta-cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin or a combination comprising at least one of the foregoing.

3. The composition of claim 2, wherein said pyrethroid compound is bifenthrin.

4. The composition of claim 1, wherein said neonicotinoid compound is selected from acetamiprid, clothianidin, imidacloprid, nitenpyram, thiacloprid, thiamethoxam or a combination comprising at least one of the foregoing.

5. The composition of claim 4, wherein said neonicotinoid compound is imidacloprid.

6. The composition of claim 1, wherein said benzoylphenylurea compound is selected from bistrifluoron, chlorfluazuron, diflubenzuron, flucycloxuron, flufenoxuron, hexaflumaron, lufenuron, novaluron, noviflumuron, teflubenzuron, triflumuron or a combination comprising at least one of the foregoing.

7. The composition of claim 6, wherein said benzoylphenylurea compound is novaluron.

8. The composition of claim 1, comprising the pyrethroid compound and the neonicotinoid compound in a weight ratio of from 1:100 to 100:1.

9. The composition of claim 1, comprising the pyrethroid compound and the benzoylphenylurea compound in a weight ratio of from 1:100 to 100:1.

10. The composition of claim 1, wherein the pyrethroid compound, neonicotinoid compound and benzoylphenylurea compound are present in a combined amount ranging from 5% to 25% by weight.

11. The composition of claim 1, further comprising an agriculturally acceptable carrier.

12. A method for control of insects, comprising contacting the insects or their food supply, habitat, breeding grounds or their locus with a synergistically effective amount of a mixture of a) a pyrethroid compound, b) a neonicotinoid compound and c) a benzoylphenylurea compound.

13. A method for control of insects, comprising contacting the insect or their food supply, habitat, breeding grounds or their locus with a synergistically effective amount of a mixture of a) bifenthrin, b) imidacloprid and c) novaluron.

14. The method of claim 12, wherein said mixture is applied in an amount of from 10 g/ha to 2000 g/ha.
